(19) United States
(12) Patent Application Publication
(10) Pub. No.: US 2026/0160153 A1
(43) Pub. Date: Jun. 11, 2026

(54) SYSTEM AND METHOD FOR EFFECTIVE WELL DESIGN

(71) Applicant: Abu Dhabi National Oil Company, Abu Dhabi (AE)

(72) Inventors: Abdul Ravoof SHAIK, Abu Dhabi (AE); Chakib Kada KLOUCHA, Abu Dhabi (AE)

(73) Assignee: Abu Dhabi National Oil Company, Abu Dhabi (AE)

(21) Appl. No.: 18/706,672

(22) PCT Filed: Nov. 12, 2021
(86) PCT No.: PCT/IB2021/060493

§ 371 Date: May 1, 2024

(51) Int. Cl. E21B 43/00; G06N 3/042

(52) U.S. Cl. CPC E21B 43/00; G06N 3/042; E21B 2200/20; E21B 2200/22

(57) ABSTRACT

The present invention relates to a method for determining a well design for exploitation of a subterranean reservoir. The method comprises the steps of providing reservoir properties, and determining, using a reservoir simulation and the reservoir properties, first oil saturation information for a first time step of at least a part of the reservoir. The invention further relates to a corresponding system for determining a well design, and a computer program.

### TECHNICAL FIELD

The present invention relates to a method for determining a well design for exploitation of a subterranean reservoir as well as to a method for exploiting a subterranean reservoir. The invention further relates to a system for determining a well design, and a system for exploiting a subterranean reservoir.

### TECHNICAL BACKGROUND

Crude oil or oil is naturally occurring in geological formations beneath the Earth's surface. Such formations can be referred to as reservoirs. Oil comprises hydrocarbons of various molecular weight, which are commonly processed for fuels and chemical feed stocks.

Producing oil from the reservoirs depends on several properties, such as e.g. the permeability of the geological formation containing the oil and the ability of the oil to flow through the formation. In early stages of the oil production, the oil is typically extracted from the reservoir. The distribution of the internal properties within the reservoir is not necessarily taken into account. With injector wells, water may be injected into the reservoir, and with production wells, oil may be extracted.

For more evolved oil production, a deeper understanding of the reservoir is necessary. Particularly, the determination of the optimal well locations is of high importance for every field development plan in order to maximize oil production with minimal costs. The determination of a cost-effective well placement strategy, however, cannot be based on intuitive judgement, since the variables affecting reservoir performance are often nonlinearly correlated. The decision on where to place the wells cannot be based on static properties of the reservoir alone, since the performance of the reservoir is typically time and process dependent. Particularly, the layout of water injectors needs to be optimized which inject water into the oil reservoir to maintain the pressure or to drive oil towards the wells to increase production. In this context, the connectivity between the injectors and wells, i.e. the injection-production relation, needs to be analyzed.

Wells do not necessarily need to run down into the earth in a perpendicular manner, so that the position of the well on the surface alone is often not the only parameter to be optimized in order to efficiently exploit a reservoir. Besides the well placement, it is thus also the well orientation or well trajectory which needs to be optimized. Herein, the term “well design” is used to refer to such a well layout which encompasses both the well placement and the well trajectory for exploiting a reservoir.

Reservoir simulation is a technique commonly used to predict the flow of fluids (e.g. oil, gas, water) in underground reservoir. Reservoir simulation is well known throughout the oil industry and in the scientific literature. Reference is exemplarily made to U.S. Pat. No. 7,765,091 B2. Mathematical models or simulation models can be used to simulate the reservoir and to optimize the oil production. One goal of a simulation model may be to simulate the fluid flow patterns according to the underlying geology. This may help finding an optimal well layout, i.e. an optimal number of wells and an optimal well placement for maximizing the oil production at preferably minimal cost.

A main objective of cost-effective well design is to optimize the placement of wells such that the net present value (NPV) is maximized. Several approaches are known to develop an effective well placement scenario. Reference is exemplarily made to the contribution of J. Islam et al., “A holistic review on artificial intelligence techniques for well placement optimization problem” in Advances in Engineering Software, 141, 102767 (2020), the contribution of A. Nwachakwu et al., “Fast evaluation of well placements in heterogeneous reservoir models using maching learning”, Journal of Petroleum Science and Engineering, 163, 463-475 (2018), and the contribution of O. Badru et al., “Well Placement Optimization in Field Development”, SPE Annual Technical Conference and Exhibition (2003).

One way of optimizing well placement is by a direct optimization with a numerical model or numerical simulation. Although such an approach may provide highly accurate results, it is infeasible due to the large amount of computer resources and run time needed.

Efforts have been made to optimize this process by using numerical models coupled with an automated optimization algorithm technique, e.g. an Genetic algorithm or a Bayesian algorithm. Reference is exemplarily made to the contribution of G. Montes, “The Use of Genetic Algorithms in Well Placement Optimization”, SPE Latin American and Caribbean Petroleum Engineering Conference (2001), and the contribution of M. A. Rajaieyamchee, “Bayesian Decision Networks for Optimal Placement of Horizontal Wells”, SPE EUROPEC/EAGE Annual Conference and Exhibition (2010). In the contribution of B. Guyagüler et al., “Uncertainty Assessment of Well-Placement Optimization”, SPE Reservoir Evaluation & Engineering (2004), a a data driven methodology is proposed to determine the optimal location of up to four water-injection wells in the Pompano field in the Gulf of Mexico.

In another approach, a so-called capacitance-resistance model (CRM) is used in which a simple semi-analytical modeling technique is used for a quick and robust identification of effective well placement. Reference is made to the contribution of R. Kansao et al., “Waterflood Performance Diagnosis and Optimization Using Data-Driven Predictive Analytical Techniques from Capacitance Resistance Models CRM”, SPE Europec featured at 79th EAGE Conference and Exhibition (2017), in which it is proposed to generate a CRM to perform uncertainty analysis and effective well placement during water flooding of heterogeneous reservoir. However, there are limitations in the CRM method. Among others, the CRM method will perform well only in a dead oil reservoir with a constant pressure level.

In the contribution of H. Wang et al., “An Interpretable Interflow Simulated Graph Neural Network for Reservoir Connectivity Analysis”, SPE Journal, 1-16 (2021), an interpretable recurrent graph neural network is proposed to construct an interacting process imitating the real interwell flow regularity. A graph neural network is used in which the adjacent matrix represents interwell relation. By means of these edges, production wells can aggregate the energy information from adjacent injection wells and update their energy state. During the training process of the network, all parameters are trained to match overserved data. However, the development of such surrogate models needs to be retrained for each full field model separately and requires large simulation efforts. Moreover, cost of training/retraining is extremely high.

It is thus an object of the present invention to increase efficiency in oil production. It is particularly an object to provide an improved technique for determining an optimal design and particularly an optimal number of wells, such as production wells and injection wells, to maximize oil production with minimal cost.

These and other objects, which become apparent from the following description, are solved by the method according to claim 1, the method according to claim 13, the system according to claim 14, the system according to claim 15, and the computer program according to claim 16.

### SUMMARY OF THE INVENTION

An aspect of the invention relates to a method for determining a well design for exploitation of a subterranean reservoir. The method may be applied in field development planning, i.e. in determining an optimal way to develop and produce from an oil or gas field by means of wells. The well design may comprise the placement of the wells, and/or the trajectories of the wells between the surface and the reservoir. Well placement may thus refer to a layout of wells, e.g. injection wells and production wells, to be drilled, and the well trajectory may refer to the orientation of the wells inside the subsurface. By choosing an optimal layout according to the present invention, the production and exploitation can be maximized. The method may be implemented as an automated process on a computer system.

In a first step (a), reservoir properties are provided, which characterize the reservoir. The reservoir properties may comprise static and/or dynamic reservoir properties. These reservoir properties may be known in advance and may have been obtained during development of the reservoir, during which several reservoir data are collected, such as seismic, geological information, fluid data and production data. The provided reservoir properties may comprise rock properties, such as e.g. porosity, capillary pressure, phase saturations and relative permeability for each phase of fluid, and fluid properties, such as e.g. oil viscosity. The reservoir properties may at least partially be derived by means of conventional reservoir simulation. Preferably, a synthetic model can be developed representing the reservoir properties of the target reservoir. In a preferred embodiment, the reservoir properties comprise at least porosity and relative permeability.

In a second step (b), first oil saturation information is determined, for a first time step of at least a part of the reservoir. This step is performed at least partially by using a reservoir simulation. The first time step may be a current or present time step, or a past time step. The oil saturation information may comprise a dynamic three-dimensional oil saturation profile for a particular well location scenario. The determination of the first oil saturation information is performed using the provided reservoir properties. The determination of the first oil saturation information for a current or present, or past time step may be done in a conventional manner known by the skilled person.

In a third step (c), second oil saturation information is determined, for a second time step of the part of the reservoir. The second time step may occur after the first time step, and may be a future time step following the first time step. The determination of the second oil saturation information is performed using the first oil saturation information and a graph-based neural network. As known by the skilled person, a graph-based neural network is a type of neural network which directly operates on the graph structure. It can be used to provide node-level, edge-level, and graph-level prediction tasks. With regard to the concept and usage of a graph-based neural network, reference is exemplarily made to US 2021/0049467 A1, and the contribution of A. Sanches-Gonzales et al., “Learning to Simulate Complex Physics with Graph Networks”, Proceedings of the 37^{th} International Conference on Machine Learning (2020).

In a fourth step (d), the reservoir well design is determined. This is done using at least the second oil saturation information. For example, various well designs such as e.g. various well placement scenarios can be tested using the second oil saturation information, to select an effective well placement scenario which maximizes the oil production and the NPV. In this context, an optimization algorithm may be implemented to select an optimal of several well design scenarios. With this optimization, the optimal well design may be determined by maximizing the hydrocarbon connected volume to a potential well, or by maximizing the equivalent distance between the potential injector wells and existing producer wells, according to certain example embodiments.

The method allows for determining an effective well design scenario and/or to optimize the number of wells to be drilled while maintaining a particular field oil production rate. Advantageously, the inventive method allows for predicting oil saturation information with limited or even no training data from simulation of the targeted reservoir. The method is build on graph-based neural networks which can learn to predict the dynamic oil distribution for a given field development plan. Advantageously, the prediction of the oil saturation can be generalized from the underlying simulation model in order to work across a range of field scale reservoir model variants without or only with limited training. It is thus possible to efficiently determine an optimal layout plan for placing wells and probing the reservoir.

In a preferred embodiment, step (b) of determining the first oil saturation information comprises providing a reservoir simulation model of the part of the subterranean reservoir. The model may be partitioned into a grid of cells as known in the art. The provided reservoir model may represent only a sector of the entire reservoir, with an areal size of e.g. 1 km² . Further, well location information for the simulation model is provided. The well location information may comprise an exemplary well placement scenario. For example, well locations may be specified in a random manner. The well locations may exemplarily be specified based on the intuition of the reservoir engineer. Well locations can also be based on a defined mathematical equation. Further, the reservoir simulation mode, the well location information and the reservoir properties are used in the context of the reservoir simulation to determine the first oil saturation information. For this limited sector model, a large number of time steps may be computed efficiently.

In a preferred embodiment, step (c) of determining the second oil saturation information comprises generating a source graph. Preferably, the source graph is generated using the reservoir properties. Further preferred, the well location information may also be used in generating the source graph. A graph used with graph-based neural networks may be a data structure comprising nodes (vertices) and edges connected together to represent information with no definite beginning or end. The edges may be considered as connections between the nodes. The edges may define the relationship one node has with another. In the graph, a node may correspond to the Cartesian center of the simulation grid cell or a corner of the grid cell. An edge may correspond to a real world grid cell connection. Using the source graph, the second oil saturation information may be determined or predicted by means of the graph-based neural network. In this manner, the graph-based neural network is efficiently used to determine the second oil saturation information from the available input.

Preferably, the source graph is based on the first oil saturation information. Preferably, the source graph includes source nodes and source edges. Thus, for example, the source graph nodes may be based on the first oil saturation information, preferably representing the dynamic three-dimensional oil saturation profile for the first time step. Preferably, the source nodes and the source edges represent the reservoir properties. In this context, the source nodes may represent the porosity, and the source edges may represent the permeability. The well location information may also be incorporated into the source graph nodes.

Further preferred, the method additionally comprises the step of generating a target graph, wherein the target graph is adapted to specify the second oil saturation information. The target graph may have a similar graph structure as the source graph. The target graph is preferably generated using the reservoir properties. The source graph and the target graph may both be generated within the concept of the graph-based neural network as appreciated by the skilled person.

In a particularly preferred embodiment, the source graph includes nodes and edges, and the step of determining the second oil saturation information comprises the step of training the graph-based neural network. That is, the network is trained to predict the oil saturation for the next time step, based on the current state. Preferably, previous states are also included for the training. During training, several subfunctions may be used to pass messages and to update the graph. The training may comprise, for each edge, using sender and receiver node information, the step of developing an edge neural network function, and computing an output edge vector. The training may further comprise, for each node, using connected edge vector information, the step of developing a node neural network function, and computing an output node vector. The edge neural network function and the node neural network function may be developed using graph-based learning techniques. Preferably, the method further comprises the step of updating the source graph using the output edge vector and the output node vector. In this manner, the graph may be updated and the network may be trained, as will be appreciated by the skilled person.

Preferably, the step of determining the second oil saturation information may comprise the step of determining the second oil saturation information from the trained graph-based neural network, particularly from the updated graph. This can be done by means of another subfunction which may be able to convert the graph node information to Cartesian information of the reservoir simulation grid cell. Using the trained graph-based neural network, oil saturation information may be determined or predicted for several future time steps. In this context, the oil saturation information may be determined for a given well design, e.g. a given well placement scenario.

In a preferred embodiment, step (d) of determining the reservoir well design comprises applying an optimization technique for testing two or more well design scenarios. Thus, several well design scenarios may be tested to determine an optimal scenario. For example, an effective well design scenario may be determined which maximizes the oil production as well as the NPV. In another embodiment, the distance between the injectors and producers may be optimized. Preferably, the number of wells to be used in exploiting the reservoir is optimized.

Advantageously, a hybrid algorithm may be used which contains a neural-network-based proxy function to mimic the role of the numerical simulator, and an optimization algorithm (e.g. genetic algorithm or Bayesian algorithm) to test various well design scenarios. This allows for decreasing the computational time by simplifying the exploration of the graph while ensuring that the accuracy of the solution is maintained.

In another aspect of the invention, the described method for determining a well design is used in a method for exploiting a subterranean reservoir. That is, as described, a well design may be determined. Subsequently, the well design may be implemented and the reservoir may be exploited, e.g. oil may be produced from the reservoir. Thus, in a first step, an optimal well design may be determined. Then, the wells may be drilled according to the determined well design, resulting in an efficient exploitation of the reservoir.

Another aspect of the invention relates to a system for determining a well design. The system comprises means for providing reservoir properties; means for determining, using a reservoir simulation and the reservoir properties, first oil saturation information for a first time step of at least a part of the reservoir; means for determining, using the first oil saturation information and a graph-based neural network, second oil saturation information for a second time step of the part of the reservoir; means for determining, using the second oil saturation information, the reservoir well design. Preferably, the system comprises suitable means for performing any preferred method steps described above.

In another aspect of the invention, the system for determining a well design is part of a system for exploiting a subterranean reservoir comprising, beside the described system for determining a well design, means for implanting the well design, and means for exploiting the reservoir.

Another aspect of the invention relates to a computer program comprising instructions for performing a method according to any one of described methods claims, when executed on a computer.

### DESCRIPTION OF PREFERRED EMBODIMENTS

In the following, the invention is described with reference to the accompanying figures, wherein:

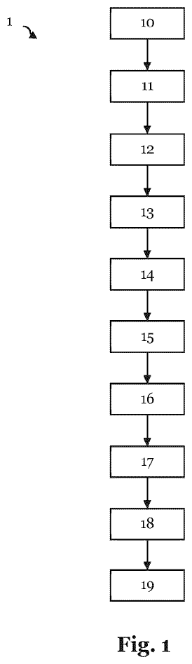

FIG. 1 is a flow chart of a method for determining a well placement according to an embodiment;

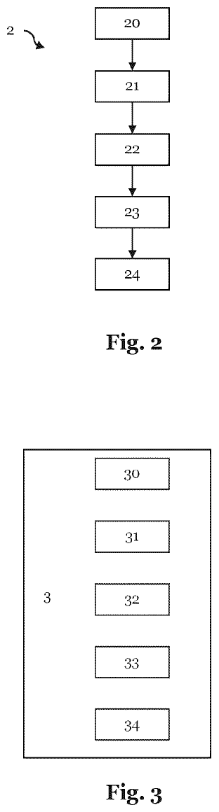

FIG. 2 is a flow chart of a method for determining a well design according to another embodiment; and

FIG. 3 is a system for determining a well design according to another embodiment.

FIG. 1 illustrates a flow chart of a method 1 for determining a well placement according to an embodiment of the invention. The skilled person understands that the same technique may also be used to determine a well trajectory, or in general to determine a well design as described herein. The method 1 is implemented as an automated process for determining the optimal locations of producing wells and injection wells in a target reservoir to eventually produce or extract oil. The training dataset used in this method may contain information such as dynamic oil saturation at a current time step, and information on a specific scenario of newly drilled wells (or various such scenarios) as well as the corresponding dynamic oil saturation profile at the next time step.

In a first step 10, from a reservoir simulation model of the target reservoir, a sector model is extracted which represents reservoir properties of the target reservoir. The areal size of the sector model may be of 1 km×1 km. In a preferred embodiment, a synthetic sector model can be developed which represents the reservoir properties. The reservoir properties comprise reservoir rock and fluid properties.

In a second step 11, a reservoir simulation software is used to simulate the sector model with random well locations. For example, the Eclipse reservoir simulation software from Schlumberger may be used. The well locations may be based on the intuition of the reservoir engineer, or may be based on a mathematical expression chosen by the reservoir engineer.

In a further step 12, the dynamic three-dimensional oil saturation profile of each well location scenario is extracted from the output of the reservoir simulation of the respective sector model. The well location information and the reservoir properties, such as porosity and permeability information, are extracted from the reservoir simulation model of the respective sector model. Steps 10-12 thus aim at determining the first oil saturation information. The data may be processed to remove artefacts, such as e.g. negative oil saturation data. The data may further be normalized.

In a further step 13, a source graph may be generated representing a physical system based on the data collected in step 12. The source graph may have a graph structure including nodes and edges. A node may correspond to a Cartesian center of the simulation grid cell. An edge may correspond to real world grid cell connections. The weight of the edges may correspond to permeability at the reservoir simulation grid cell edge. The source nodes also contain features representing the dynamic oil saturation information of the current time step, and spatial information of reservoir rock properties, such as e.g. porosity. The well location information is incorporated as an embedded feature into the source graph nodes. Dynamic oil saturation information of previous time steps (not described here) may be treated as an additional feature.

In a further step 14, a target graph is generated. The target graph also has a graph structure consisting of nodes and edges. The target graph contains information about the dynamic oil saturation at the next, preferably future time step(s). The target graph further contains spatial information of reservoir rock properties, such as porosity and permeability of the simulation grid cell. The target graph has a graph structure similar to that of the source graph. The only difference is that the target graph contains information about the oil saturation at future time steps whereas the source graph contains information about the oil saturation at current/previous time steps.

In a further step 15, using a mesh-based graph networks concept, a graph-based neural network is trained to predict the oil saturation profile at the next time step from the current state using the source graph and the target graph build during previous time steps. Steps 13-15 thus aim at determining the second oil saturation information, i.e. the oil saturation at future time steps of each well location scenario.

Both the current state and some of the previous time steps may be considered for in step 15. The network may be developed with the following features: Properties being constant throughout the reservoir (such as e.g. reservoir brine viscosity) are treated as global features, which may be used in training.

The network has several subfunctions to pass messages and to update the graph in the following way: For each edge, using sender and receiver node information, an edge neural network function is developed to compute an output edge vector. For each node, using connected edge vector information, a node neural network function is developed to compute the output node vector. Both functions may be implemented using a graph-based learning technique. In this context, a recurrent neural network or graph attention network or graph convolution neural network may be used in some implementations.

Using the output node vector and the output edge vector, the graph may be updated and the network may be trained.

In a furthest step 16, the output of step 15 is fed into another subfunction which extracts the dynamic oil saturation from the graph. This subfunction can be a type of neural network converting the graph node information to Cartesian location of the reservoir simulation grid cell.

In a further step 17, similar to step 13, a reservoir simulation model of the respective target model may be used to develop a new source graph.

In a further step 18, the trained graph neural network developed in step 15 is used to predict the dynamic oil profile for a given well placement scenario at future time steps.

In a further step 19, an optimization technique is used to test various well placement scenarios with the help of the trained graph-based neural network. For example, a genetic algorithm or a Bayesian algorithm may be used in this context. In another embodiment, reward-based machine learning techniques may be used in this context. In this manner, an effective well placement scenario may be selected which maximizes the oil recovery as well as the NPV. In another preferred embodiment, the maximizing distance between the injectors and producers may be used as an optimization parameter. Step 19 thus aims at determining the reservoir well placement.

FIG. 2 illustrates a flow chart of a method 2 for determining a well design according to another embodiment of the invention. The method 2 comprises the step 20 of providing reservoir properties; the step 21 of determining, using a reservoir simulation and the reservoir properties, first oil saturation information for a first time step of at least a part of the reservoir; the step 22 of determining, using the first oil saturation information and a graph-based neural network, second oil saturation information for a second time step of the part of the reservoir; and the step 23 of determining, using the second oil saturation information, the reservoir well design.

FIG. 3 illustrates a system 3 for determining a well design according to another embodiment of the invention. The system comprises means 30 for providing reservoir properties; means 31 for determining, using a reservoir simulation and the reservoir properties, first oil saturation information for a first time step of at least a part of the reservoir; means 32 for determining, using the first oil saturation information and a graph-based neural network, second oil saturation information for a second time step of the part of the reservoir; and means 33 for determining, using the second oil saturation information, the reservoir well design.

1. A method for determining a well design for exploitation of a subterranean reservoir, comprising:
(a) providing reservoir properties;
(b) determining using a reservoir simulation and the reservoir properties, first oil saturation information for a first time step of at least a part of the reservoir;
(c) determining, using the first oil saturation information and a graph-based neural network, second oil saturation information for a second time step of the part of the reservoir;
(d) determining, using the second oil saturation information, the reservoir well design.

2. The method of claim 1, wherein step (b) comprises:
providing a reservoir simulation model of the part of the subterranean reservoir;
providing well location information for the simulation model;
determining, using the reservoir simulation model and the well location information and the reservoir properties, the first oil saturation information.

3. The method of claim 1, wherein step (c) comprises:
generating, using the reservoir properties, a source graph;
determining, using the source graph, the second oil saturation information.

4. The method of claim 3, wherein source graph is based on the first oil saturation information.

5. The method of claim 3, wherein the source graph includes source nodes and source edges.

6. The method of claim 5, wherein the source graph nodes represent the well location information.

7. The method of claim 5, wherein the source nodes represent the first oil saturation information and wherein the source edges represent reservoir properties.

8. The method of claim 5, wherein the step of determining the second oil saturation information comprises the step of training the graph-based neural network, comprising:
for each edge, using sender and receiver node information:
developing an edge neural network function, and
computing an output edge vector;
for each node, using connected edge vector information:
developing a node neural network function, and
computing an output node vector.

9. The method of claim 8, further comprising the step of updating the source graph using the output edge vector and the output node vector.

10. The method of claim 8, wherein the step of determining the second oil saturation information comprises the step of determining the second oil saturation information from the trained graph-based neural network.

11. The method of claim 1, wherein step (d) comprises:
applying, using the trained graph-based neural network, an optimization technique for testing two or more well design scenarios, preferably for optimizing the number of wells to be used in exploiting the reservoir.

12. The method of claim 1, wherein the reservoir properties comprise static and/or dynamic reservoir properties, preferably one or more of porosity and permeability.

13. A method for exploiting a subterranean reservoir, comprising:
determining a well design, wherein the determination is performed according to the method of claim 1;
implementing the well design;
exploiting the reservoir.

14. A system for determining a well design, comprising:
means for providing reservoir properties;
means for determining, using a reservoir simulation and the reservoir properties, first oil saturation information for a first time step of at least a part of the reservoir;
means for determining, using the first oil saturation information and a graph-based neural network, second oil saturation information for a second time step of the part of the reservoir;
means for determining, using the second oil saturation information, the reservoir well design.

15. The system for exploiting a subterranean reservoir, comprising:
the system according to claim 14 for determining a well design;
means for implementing the well design;
means for exploiting the reservoir.

16. A computer program comprising instructions for performing a method according to claim 1, when executed on a computer.
